(19) United States
(12) Patent Application Publication
(10) Pub. No.: US 2018/0146757 A1
(43) Pub. Date: May 31, 2018

(54) Fully Integrated Child Carrier and Suitcase Combination

(71) Applicant: Jaspal Singh Johar, Los Angeles, CA (US)

(72) Inventor: Jaspal Singh Johar, Los Angeles, CA (US)

(21) Appl. No.: 15/363,506

(22) Filed: Nov. 29, 2016

(51) Int. Cl. A45C 9/00; A45C 5/03; A45C 5/14; A45C 13/26; A45F 3/04; A45F 4/02; B62B 7/10; B62B 9/10; B62B 9/20

(52) U.S. Cl. CPC A45C 9/00; A45C 5/03; A45C 5/141; A45C 13/262; A45F 3/04; A45C 2005/142; B62B 7/105; B62B 9/10; B62B 9/20; A45C 2009/005; A45F 4/02

(57) ABSTRACT

A rugged suitcase and child carrier combination. The shell comprises a top half and bottom half each defining a hollow cavity. A foldable seat assembly is suspended in an opening defined by open halves of the shell, and various paraphernalia such as toys, bottles, entertainment devices, blankets, clothing, and food stuffs, among others, may be stowed in the hollow cavity defined by either of the top and bottom halves of the hinged shell. A plurality of wheels may be disposed on the bottom half of the device, and a telescoping handle may be disposed on an upper end of the top half of the shell to enable steering the device. The entire combination may be securably collapsed so that the seat assembly, as well as any stowed paraphernalia, is fully and securely encapsulated within the shell which may optionally be conveyed as a rolling suitcase.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to child carriers and, more particularly, to combined stroller and storage devices capable of conversion from a means for transporting a child into a rugged and stowable, rollable suitcase, backpack, or other storage device.

### BACKGROUND

Child care providers, such as parents, baby sitters, and others, are often equipped with a variety of bulky items to ensure that any children in their care may be adequately taken care of in any number of predictable and unpredictable situations alike. For this reason, many child care providers are known to wear bulky, so-called “diaper bags” or totes equipped with pockets and other compartments for fashionably stowing bottles, diapers, extra clothing, toys, and food, among other items. In addition, child carriers such as strollers are often deployed to conveniently convey children. Conveying the children, carriers, and storage devices can be cumbersome and add to stress already associated with watching after children.

Some attempts to consolidate space occupied by the items and children by combining child carriers with storage devices have been proposed. For instance, U.S. Pat. No. 5,257,799 to Cone et al. and U.S. Pat. No. 7,188,858 to Harenstine et al., disclose strollers with integrated storage compartments. Harenstine in particular suggests folding the stroller to enable relatively compact stowage of the unused stroller. However, this is deficient because it fails to incorporate solutions for items stowed in compartments of the stroller prior to folding. These items must be removed and stowed separately in order to fold the stroller. In cramped spaces, such as small cars, busses, and even air planes, it may be difficult if not impossible to locate space to house, even if temporarily, a separated tote and stroller.

Others have attempted to solve this problem by incorporating child carriers into the body of dedicated traveling cases such as backpacks and/or suitcases. For instance, U.S. Pat. No. 6,932,427 to Tamura teaches disposing a folding chair on an outside of a typical suitcase. Similarly, U.S. Pat. No. 5,899,467 to Henkel describes a carry-on stroller case having a moveable upper compartment. Unfortunately, placing seating mechanisms on an external portion of the described cases may be unsightly, and the assemblies may be vulnerable to tampering.

Thus, there remains a need for a suitcase or other transportable storage device combined with a fully integrated child carrier.

### SUMMARY

The present disclosure is directed to a fully integrated storage device that may be optionally or alternatively deployed as a rollable child carrier, including means for stowing paraphernalia, or as a fully encapsulated rollable or wearable storage device.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the fully integrated child carrier and suitcase combination may comprise an outer shell, a foldable seat assembly, wheels, and a telescoping handle. The device may be optionally and alternatively deployed as a child carrier, wherein the seat assembly may be suspended in an open space defined by top and bottom halves of the shell, or as a suitcase, backpack, or other transportable storage device, or even travel kit, wherein the seat assembly is folded and securely encapsulated within a hollow cavity defined by halves of the shell.

More particularly, the shell may be defined by a top half and a bottom half. Each of the top and bottom halves comprise an inside and an outside, an upper end, and a lower end spaced apart by opposing side portions. Each half may be formed to define a hollow cavity, and each half may be hingedly connected to the other along its lower end to define a securably closeable clamshell case, such as a variety of suitcases known in the art. Additionally, however, the foldable seat assembly may be suspendable such that when each of the top and bottom halves are opened, a seat, configured to receive a child, may be deployed for use. Various mechanisms known to those skilled in the art, such as for example only and not limitation, may be used to ensure that the seat assembly is prevented from folding or collapsing while in use.

In some embodiments, concave portions of the top and bottom shell, which together define the hollow cavity of the shell, may be operative to receive paraphernalia such as any toys, food, clothing, diapers, wipes, bottles, blankets and other goods as may be necessitated over the course of travel with a child. Indeed, it is contemplated that additional pouches and even anchoring straps may be provided to enable organization of such paraphernalia, as desired, and further securely maintaining such paraphernalia within such concave portions.

The plurality of wheels may be disposed on the bottom half of the shell so that the device may be rollably conveyed by a care giver or other user. It should be noted, however, that the number and arrangement of wheels is not dispositive. Indeed, any number of wheels as needed, defined by any size and any arrangement may be sufficient to practice the invention. In some embodiments, however, one or more of the wheels may be particularly disposed and operative to enable steering the device when in use as a rollable child carrier.

Additionally, the telescoping handle may be disposed along the upper end of the top half of the shell to enable a child care provider or other user to forcibly, rollably convey and/or steer the device when configured as a child carrier.

As described above, the seat assembly may be foldable such that upon closure of the clam-like top and bottom halves comprising the shell, the seat assembly may be efficiently enveloped or encapsulated within the hollow cavity defined by the top and bottom halves. Likewise, any paraphernalia securely placed within the concave portions of the top and bottom halves may also be securely enveloped or encapsulated. Still, the plurality of wheels and telescoping handle may remain accessible from the outside of the shell so that a user may rollably convey the enclosed seat and paraphernalia in the manner of a suitcase. In some embodiments, it is contemplated that one or more straps may be disposed on a portion of the outside of the shell so that the closed shell may conveyed by wearing, rather than rolling, the device.

Enclosing the seat assembly and paraphernalia in accordance with the various embodiments may be beneficial, for instance, over the course of air travel, when passengers are asked to stow their personal and other “carry-on” items in bins above or in front of their seats. Providing a compact shell operative to encapsulate the entirety of a child seat therein, as well as a variety of paraphernalia, may ensure that such device is readily stowable while avoid damage to and/or loss of such encapsulated elements.

It is contemplated that additional elements, such as child engagement devices, may be integrated with the apparatus. For instance, a toy, such as a steering wheel may be collapsibly secured to a portion of the seat assembly so that when the seat assembly is securably folded within the shell, such engagement device may be as well. In other embodiments, a rod, stand, or mount may be secured to a portion of the seat assembly, or even to a portion of the shell, to enable integrating an unincorporated engagement device. For instance, a mount may be provided to optionally secure and display a personal electronic device to a child maintained in the seat assembly. Bottle holders, toy straps, seat belts, and other elements are similarly contemplated and known to those skilled in the art.

Thus, it is an object of the invention to fully encapsulate a child seating assembly when not in use.

It is another object of the invention to stow items in addition to a fully encapsulated child seating assembly.

It is still another object of the invention to enable alternative means of conveying the fully encapsulated child seating assembly and additional stowed items.

It is yet another object of the invention to integrate stowable child engagement devices with the combined child carrier and storage device.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective view of a fully integrated child carrier and suitcase combination in accordance with one embodiment of the invention.

FIGS. 2A and 2B illustrate successive side views of the transition of the fully integrated child carrier and suitcase combination from use as a child carrier to use as a suit case, in accordance with one embodiment.

FIG. 3 shows an embodiment of the fully integrated child carrier and suitcase combination in a securely collapsed configuration.

FIG. 4 shows a perspective view of another embodiment of the fully integrated child carrier and suitcase combination in a securely collapsed configuration.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

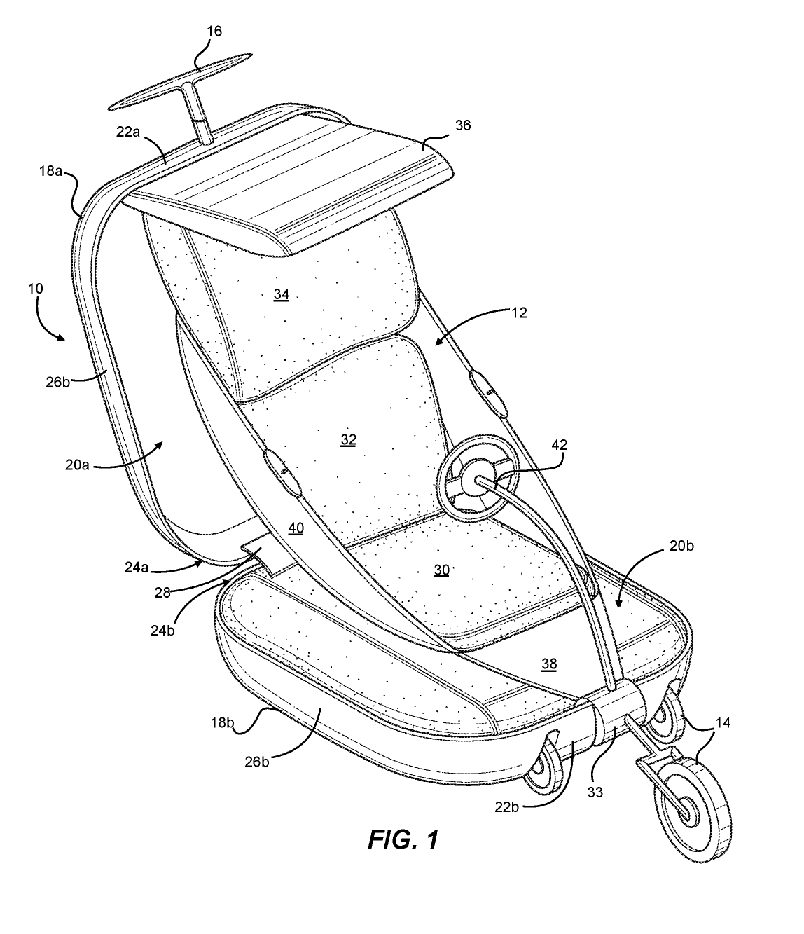

With reference to FIG. 1 the combination child carrier and storage device may comprise a shell 10, a seat assembly 12, a plurality of wheels 14, and a telescoping handle 16.

In particular, the shell 10 may comprise a top half 18a and a bottom half 18b which may each define concave portions 20a and 20b configured to form a selectably closeable clamshell case known to those skilled in the art. It is contemplated that the top and bottom halves 18a, 18b may comprise rugged material such as thermoplastic, including for example ABS and/or polycarbonate. However, the top and bottom halves 18a, 18b may alternatively be defined by skeletal rods, known to those skilled in the art, and wrapped in rugged yet flexible fabric, such as, for example only and not limitation, nylon, canvas, or even vinyl. Thus the material used and particular construction of the shell, should not be dispositive. Each half 18a, 18b of the shell 10 may be further defined by an upper or top end 22a, 22b, and a lower end 24a, 24b spaced apart by a side portion 26a, 26b. Then, each half 18a, 18b may be connected to other along its lower end 24a, 24b to define a securably closeable clamshell case, such as a variety of suitcases known in the art. The halves 18a, 18b may be connected by, for example, a hinge 28, though other means of connecting may be apparent.

As may be seen in the figures, the seat assembly 12 may be suspended in an open space between the top and bottom halves 18a, 18b and configured to receive a child. The seat assembly 12 may take a variety of forms comprising a variety of materials, such as those made from natural and synthetic fibers, thus only one exemplary embodiment is pictured for the sake of brevity. The seat assembly 12 may comprise a seat cushion 30, a back cushion 32, a head rest 34, a shade 36, and even a footrest 38. It may be seen that the seat assembly 12 may further comprise protective sides 40 or arm rests which may prevent the child from undesirably exiting the seat. In some embodiments, the protective sides 40 may be lockable to prevent the seat assembly 12 from folding while in use.

Though not pictured, additional means for protecting the child are contemplated and may include, for example, a seatbelt.

In some embodiments, hollow cavities 20a, 20b defined by the top and bottom halves 18a, 18b of the shell 10, may be operative to receive paraphernalia such as any toys, food, clothing, diapers, wipes, bottles, blankets and other goods as may be necessitated or desired over the course of travel with a child. Indeed, it is contemplated that additional pouches and even anchoring straps may be provided to enable organization of such paraphernalia and further securely maintaining such paraphernalia within such hollow cavities.

Additional integrated elements may be foldably stored within the hollow cavity 18a, 18b as well. For instance, a device for engaging a child seated in the seat assembly 12 may be integrated on a portion of the shell 10 or seat assembly 12. As shown in FIG. 1, one embodiment of such an engagement device 42 may be a steering wheel or other toy configured to distract or engage a child. Other, or additional, engagement devices are contemplated, however. For instance, in some embodiments, a mount for a personal electronic device may be integrated with the shell 10 or seat assembly 12 to display a game or video to the seated child. In some embodiments, other toys or electronics may be similarly integrated.

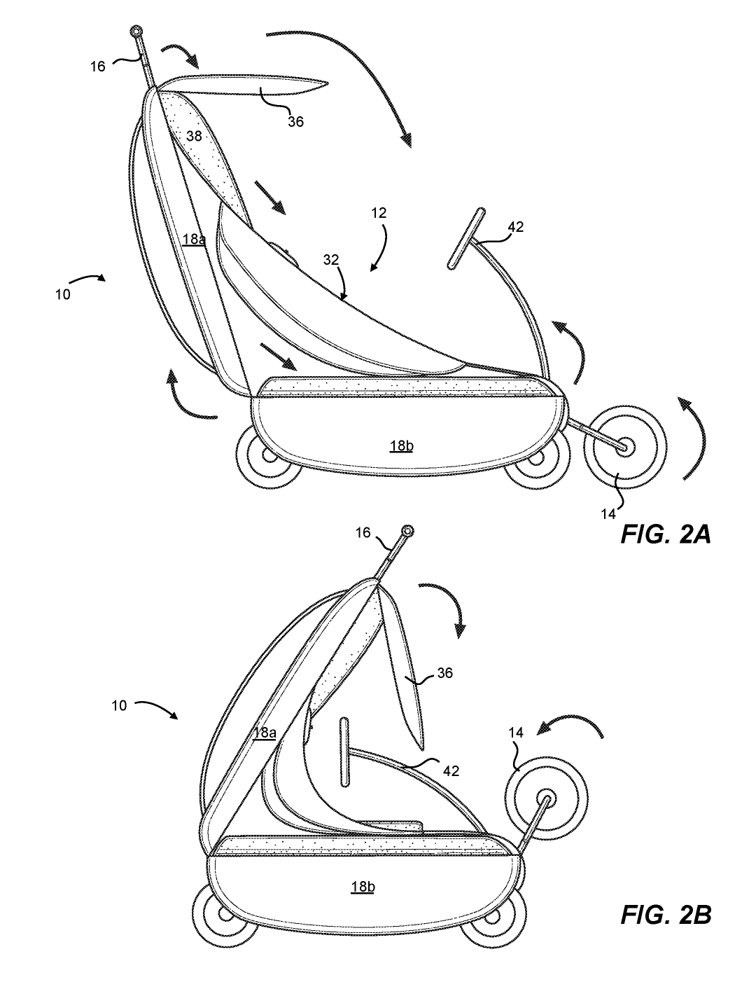

Turning to FIGS. 2A and 2B, conversion of the child carrier described for use as a suitcase or other the storage device may be made more clear. In particular, the seat assembly 12 may be foldable such that upon closure of the clam-like top and bottom halves 18a, 18b comprising the shell 10, the seat assembly 12, as well as any stowed paraphernalia, may be efficiently enveloped or encapsulated within the hollow cavity defined by the top and bottom halves 18a, 18b. Thus, it may be seen that the shade 36 may fold onto or over the headrest 34, which may itself fold over the backrest and/or seat 32. Likewise, the engagement device 42 and even, in some embodiments, one or more wheels 14, may rotate inward, such as from rotating member 33 shown in FIG. 1, to be stowed as well. Indeed, in some embodiments, various elements, including for example, the one or more wheels 14 and even engagement device 42 may be fully detachable from the shell 10 for stowing within the hollow cavity or elsewhere.

One skilled in the art will recognize that materials comprising the seat assembly 12 may vary and even be chosen for their particular flexibility and even compressibility. Indeed, it is contemplated that in some embodiments, for example only, hinging members may connect portions of the seat assembly 12 to aid the folding action. It should also be noted that alternative, or additional, manners of folding the suspended seat assembly 12 may be practiced without departing from the invention. For instance, though the figures depict a single fold corresponding to the joint between the seat 32 and backrest, elements may be arranged to effect an accordion or other style fold.

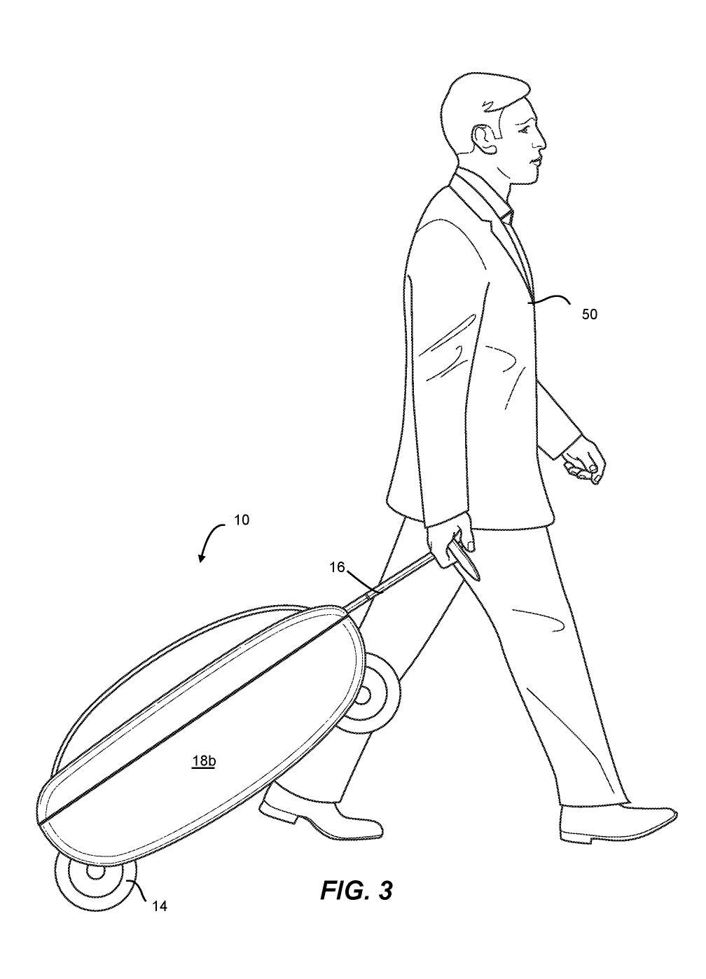

Still, it is contemplated that the plurality of wheels 14 and telescoping handle 18 may remain accessible from the outside of the shell 10 so that a user 50 may rollably convey the enclosed seat and paraphernalia in the manner of a suitcase, as demonstrated for example in FIG. 3.

With further reference to FIG. 3, the stroller may be folded into a compact valise or suitcase conveniently configured for storage during travel. Indeed, providing wheels 14 and a telescoping handle 16, may permit convenient transportation by an adult user 50 or even a child when the child carrying seat assembly is not in use, or rather, encapsulated in the shell 10. One skilled in the art will recognize that the particular arrangement, number, and configuration of the wheels 14 may vary. Although drawn as common disk-shaped wheels securely, but rotatably, recessed along an outside of the bottom half 18b of the shell 10 it is contemplated that the wheels may be secured externally along an outside of the bottom half 18b as other rolling members, such as swiveling caster wheels known to those skilled in the art. As another example, the wheels 14 may be formed as rollerballs, also known to those skilled in the art, recessed along an outside of the bottom half 18b of the shell 10. Of course, the foregoing should not be seen as limiting examples, and are provided for the sake of illustrating possible alternatives only.

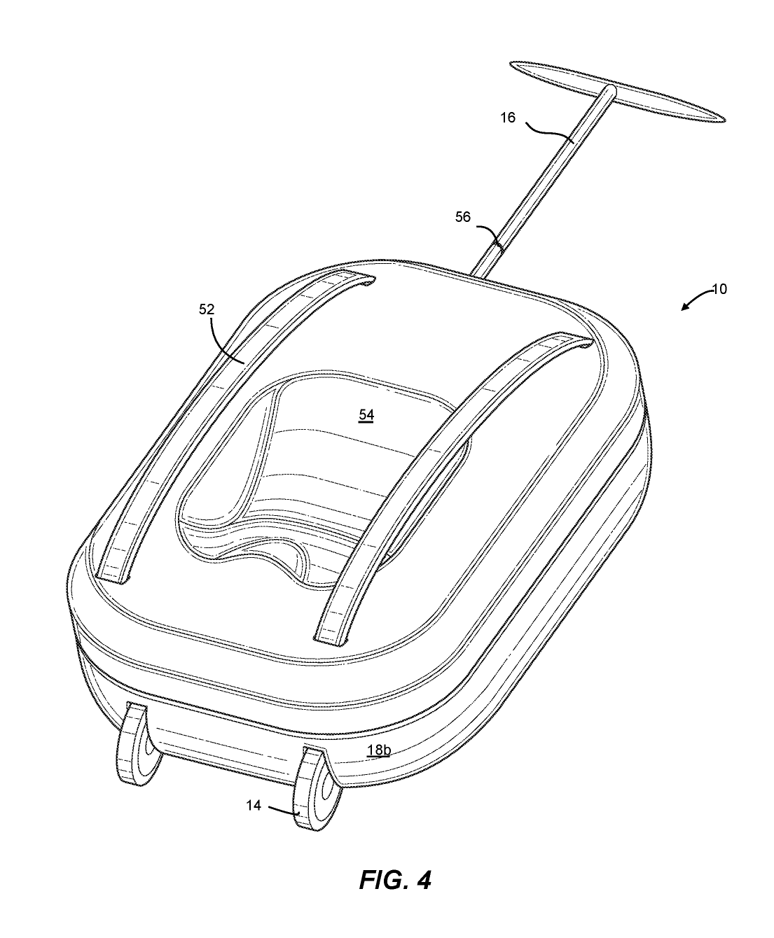

Although it is contemplated that the top and bottom halves of the shell may be folded to fully encapsulate each of the above-mentioned features, it is contemplated that still others may remain accessible from outside of such shell. With reference to FIG. 4 for instance, it may be seen that a portion of the outside of the bottom half 18b of the shell 10 may be molded 54 to support a child resting against, or even sitting on, the device while such device is rollably conveyed in its folded configuration as a suitcase behind an adult.

It is contemplated that it may be desirable to alter the angle defined by the bottom half 18b and surface supporting the assembly, such as the ground. For instance, lowering the angle of inclination may support a child resting on a molded 54 portion more securely. Thus, to support ergonomic conveyance of the assembly by an adult or other user while maintaining such inclination, it is contemplated that the telescoping handle 16 may be jointed 56 to enable improved or more comfortable access to the handle by optionally angling the handle 16 itself.

One or more straps 52 may be disposed on a portion of the outside of the shell 10 so that the closed shell 10 may conveyed by wearing, rather than rolling, the device. This may desirably enable hands-free transportation of the converted child carrier and storage device. Of course, the particular positioning and character of the straps 52 illustrated is offered by way of example only and not of limitation. It should be apparent that the straps may be adjustable and may also or alternatively be placed to enhance ergonomic use of the device.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For instance, the particular shape and size defined by various elements comprising the carrier and suitcase combination may vary according to aesthetic and functional needs. Though drawn with rounded sides in the figures, it is contemplated that the sides may be strictly quadrilateral, or any other shape, as may be desired. Indeed, forming the carrier and suitcase combination as a certain shape may be beneficial for transport. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the fully integrated child carrier and suitcase combination with which that terminology is associated. In general, the terms used in the following claims should not be constructed to limit the fully integrated child carrier and suitcase combination to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the fully integrated child carrier and suitcase combination is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the fully integrated child carrier and suitcase combination.

1. A convertible child carrier device, comprising:
a closable clamshell case comprising:
a) a top half having a top half inside, a top half outside, a top half upper end, and a top half lower end, wherein the top half defines a top half cavity extending to the top half inside, the top half outside, the top half upper end, and the top half lower end; and
b) a bottom half having a bottom half inside, a bottom half outside, a bottom half upper end, and a bottom half lower end, wherein the bottom half defines a bottom half cavity extending to the bottom half inside, the bottom half outside, the bottom half upper end, and the bottom half lower end;
a foldable seat assembly suspended in a central opening, the central opening comprising the top half cavity and the bottom half cavity of the closeable clamshell case, wherein the foldable seat assembly is configured to receive a child;
a telescoping handle disposed on the outer side of the upper end of the top half; and
a plurality of rolling means disposed along the outside of the bottom half of the closeable clamshell case, wherein closing the closeable clamshell case causes the seat assembly to fold upon itself within the central opening, such that the seat assembly and any paraphernalia stored within the central opening is fully encapsulated by the top and bottom halves of the closeable clamshell case.

2. The convertible child carrier device of claim 1, further comprising an engagement device rotatably stowable in the central opening.

3. The convertible child carrier device of claim 2, wherein the engagement device comprises a mount operative to removeably and securely display a personal electronic device.

4. The convertible child carrier device of claim 1, further comprising at least one adjustable strap disposed along the top half outside and operative to enable wearing the device when securably collapsed.

5. The convertible child carrier device of claim 1, wherein the foldable seat assembly comprises at least one of a cushioned seat, a cushioned back rest, a cushioned head rest, and a shade.

6. The convertible child carrier device of claim 1, wherein the outside of the bottom half is molded to define a void configured to receive a child for resting along the outside of the device.
